(19) United States
(12) Patent Application Publication
(10) Pub. No.: US 2006/0010210 A1
(43) Pub. Date: Jan. 12, 2006

(54) Method for automatically handling undesired electronic mail in communication networks at the recipient end

(76) Inventor: Walter Keller, Ratingen (DE)

Correspondence Address: THE MAXHAM FIRM, 750 "B" STREET, SUITE 3100, SAN DIEGO, CA, 92101, US

(21) Appl. No.: 10/528,284

(22) PCT Filed: Sep. 17, 2003
(86) PCT No.: PCT/DE03/03094

§ 371 Date: Aug. 29, 2005

(51) Int. Cl. G06F 15/16

(52) U.S. Cl. 709/206

(57) ABSTRACT

The invention relates to a method for automatically rejecting/avoiding undesired e-mails in mailboxes at the recipient end, according to which the address of the sender of the e-mail is compared with a recipient-specific list of authorized senders and is saved in the mailbox only if said address matches that of an authorized sender. A second, optional mailbox (junk mailbox, JMB) which is also accessible at the recipient end is provided for receiving all unauthorized messages. Optionally, automatic functions such as cyclical deletion, virus scanning, separation of stations and/or executable software, sender analysis, sending of stop requests and/or warnings, etc., can be configured in the system.

### BACKGROUND OF THE INVENTION

1. Field of the Invention

This invention pertains to a process to automatically handle undesired electronic mail in communication networks.

2. Background

Large portions of the population use electronic mail today for commercial or private purposes, or both. In this regard, the so-called “e-mail” process using standardized TCP/IP-based internet protocol (IETF RFC 791) is most popular.

The basic procedure is shown in FIG. 1. A sender, for example a personal computer (PC) 1.1, sends an e-mail 1.2 via the public internet 1.3, containing a target address of a recipient 1.7. The internet assigns the email to one of the internet service provider's (ISP) 1.4 e-mail servers 1.5 based on agreed-upon protocols and name conventions. This server administers the recipient addresses. The e-mail server 1.5 places the message into the recipient's mailbox 1.6, from which the recipient 1.7 can retrieve it.

The recipient address can be a so-called “alias” address containing plain language identification, followed by the internet service provider address (ISP address) and the country identification, such as:
Heinz.Mustermann@recipient-ISP.de.

The mail protocol also contains a sender's address, which is constructed in the same sense, such as:
Schrott-Versandt@sender-ISP.de.

Unfortunately, misuse of electronic mail is very common. Dubious senders annoy large sections of the population with undesired e-mails, which in practice are often of a pornographic, radical and/or advertising nature.

The purpose of this is to attract money through the back door from unsuspecting customers. Often, viruses also find their way into PCs this way. This type of undesired mail delivery is often called “junk mail” in internet parlance.

### SUMMARY OF THE INVENTION

A purpose of this invention is to propose a method to automatically handle undesired electronic mail in communication networks from the receiving end in order to stop the undesired annoyance of the recipient by junk mail.

According to an embodiment of the invention, the sender address accompanying an incoming e-mail is automatically compared to an electronically accessed list of authorized sender addresses assigned to the receiver, the comparison being performed before the e-mail is stored in a mailbox of the recipient. The only e-mails transferred to the receiver's mailbox are those that had clearly been sent by authorized senders.

In a preferred embodiment of the invention, two logically and/or physically separate mailboxes are provided, wherein the e-mail server sends to the second JMB mailbox all incoming e-mails that indeed have the subscriber's correct recipient address but are not contained in the sender list on the receiving side, thus making them available for further processing by the internet service provider, administrative authorities, or by the recipient, or any combination of processors.

Preferably, the e-mails can be put through an automatic handling or analysis process, or both, which can be configured by the recipient or by the ISP, or both, in the e-mail server, in a comparison device and/or at least one of the mailboxes, the process initiated and configured either on a case-by-case basis or permanently. In particular, all programs that execute automatically that were sent as attachments to the e-mails can be separated in the JMB.

On the other hand, the e-mail can be analyzed to see if there is serial, incremental user identification occurring, which would enable inferences to be drawn concerning automatic attempts at breaking into the e-mail system. This additional analysis makes it possible to very easily identify malicious individuals who automatically try all possible codes.

According to a further development of the invention, discontinuation requests or cease and desist demands can be generated automatically and delivered to the senders of undesired e-mails.

Furthermore, virus checks can be carried out, for example at an established time of day or each time a message arrives, and the contents of the JMB can be cyclically deleted at specific time intervals.

### BRIEF DESCRIPTION OF THE DRAWING

The purposes, advantages, and features of the invention will be more readily perceived from the following detailed description, when read in conjunction with the accompanying drawing, wherein:

FIG. 1 is a schematic representation of an e-mail delivery system via the internet; and

FIG. 2 is a representation of an e-mail delivery system in accordance with the method of the invention.

### DETAILED DESCRIPTION OF THE PREFERRED EMBODIMENTS

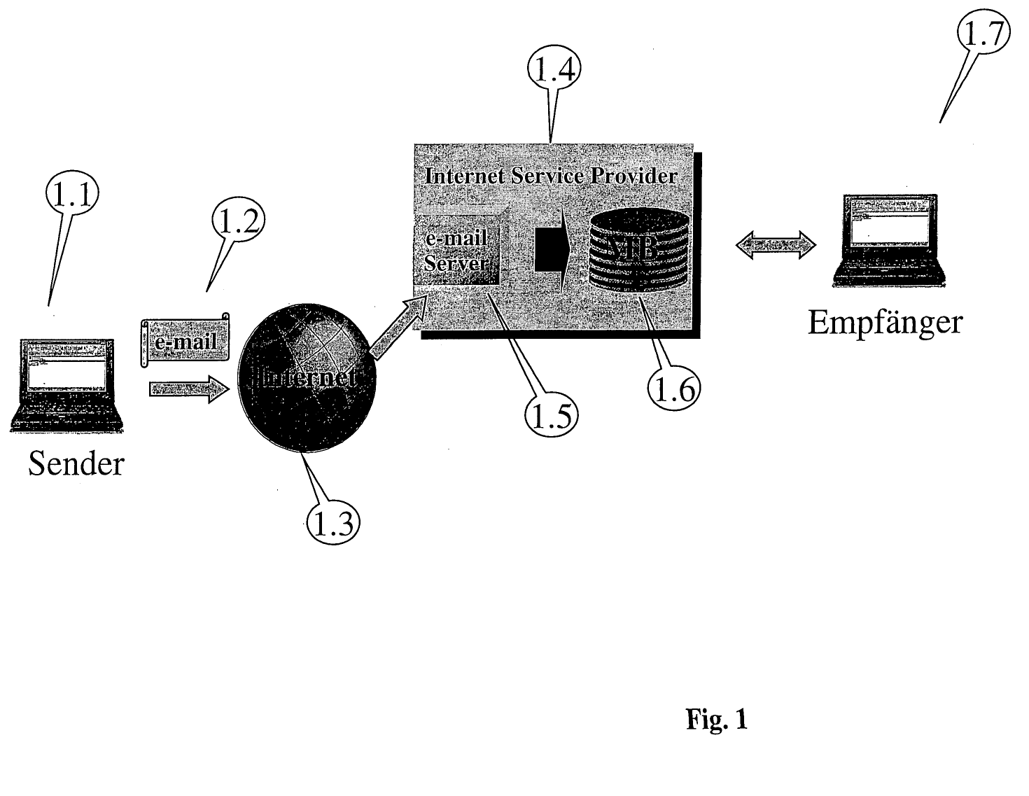

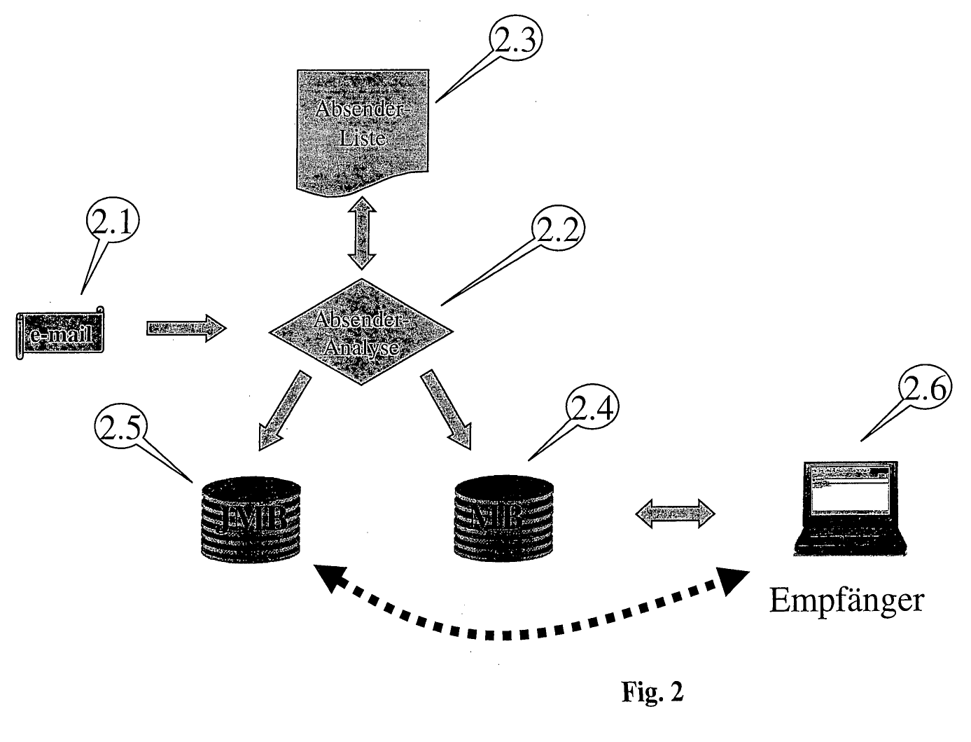

With the general e-mail delivery method according to FIG. 1 as a starting point, FIG. 2 shows the method according to the invention. The sender address of the e-mail 2.1 arriving at the ISP 1.4 is automatically verified in an analysis device 2.2 of the e-mail server 1.5. The sender addresses authorized specifically for the recipient are stored in a database 2.3 in the form of a sender list. E-mails with sender addresses that are contained in list 2.3 are considered legitimate and are delivered to mailbox MB 2.4 of recipient 2.6.

All other e-mails with correct recipient addresses but with unauthorized sender addresses are either thrown out or are delivered to a second mailbox (Junk Mail Box JMB) 2.5. The recipient can inspect the contents of JMB 2.5 as necessary.

In this way, recipient 2.6 is not bothered by undesired senders who do in fact know his correct e-mail address but are not authorized by the recipient. By introducing the optional JMB 2.5, the subscriber can still inspect all mails if he wishes.

Furthermore, there are automatic configuration options in the sender analysis and/or in at least one of the mailboxes 2.4, 2.5 that can be set up by the subscriber or by the ISP, or by both. The generation and administration of the sender list is the responsibility of the respective subscriber, that is, the owner of the MB. Optionally, he can automatically transfer mail sender information in the messages to the MB by selecting the respective mail message and “clicking” a function/command provided for this purpose. This alleviates having to manually enter the sender information.

Incoming mails in JMB 2.5 can be checked for viruses or for illegal or immoral content. Attachments, for example, executable programs that could contain viruses, can be deleted and/or inferences can be drawn about the sender based on the recipient address fields and discontinuation requests or cease and desist demands can be automatically delivered.

1-8. (canceled)

9. A method to automatically handle undesired electronic mail (e-mail) in communication networks at the receiver, the method comprising:
automatically comparing the sender address accompanying an incoming e-mail to an electronically accessed list of authorized sender addresses assigned to the receiver; then
storing the e-mail in a mailbox MB of the recipient, wherein the only e-mails transferred to the receiver's mailbox are those that had clearly been sent by authorized senders; and
performing an analysis to see if there is serial, incremental user identification occurring so that conclusions can be drawn concerning automatic attempts at breaking into the e-mail system.

10. The method according to claim 9, wherein there are two logically or physically, or both, separate mailboxes, said mailbox MB and a junk mailbox JMB, wherein the e-mail server sends to the JMB mailbox all incoming e-mails that indeed have the subscriber's correct recipient address but are not contained in the sender list on the receiving side, thus making them available for further processing selectively by the internet service provider, the administrative authorities, and by the recipient.

11. The method according to claim 9, wherein the incoming e-mails are selectively put through an automatic handling and analysis process, which can be selectively configured by the recipient and by the ISP, selectively in the e-mail server, in a comparison device, and in at least one of the mailboxes, said process initiated and configured either on a case-by-case basis or permanently.

12. The method according to claim 10, wherein the incoming e-mails are selectively put through an automatic handling andanalysis process, which can be selectively configured by the recipient andr by the ISP, selectively in the e-mail server, in a comparison device, and in at least one of the mailboxes, said process initiated and configured either on a case-by-case basis or permanently.

13. The method according to claim 9, wherein all executable programs sent as attachments to e-mails are automatically separated in the JMB.

14. The method according to claim 10, wherein all executable programs sent as attachments to e-mails are automatically separated in the JMB.

15. The method according to claim 11, wherein all executable programs sent as attachments to e-mails are automatically separated in the JMB.

16. The method according to claim 12, wherein all executable programs sent as attachments to e-mails are automatically separated in the JMB.

17. The method according to claim 9, wherein if an undesired e-mail is received, discontinuation requests, or cease and desist demands, can be generated automatically and delivered to the sender.

18. The method according to claim 10, wherein if an undesired e-mail is received, discontinuation requests, or cease and desist demands, can be generated automatically and delivered to the sender.

19. The method according to claim 11, wherein if an undesired e-mail is received, discontinuation requests, or cease and desist demands, can be generated automatically and delivered to the sender.

20. The method according to claim 12, wherein if an undesired e-mail is received, discontinuation requests, or cease and desist demands, can be generated automatically and delivered to the sender.

21. The method according to claim 9, wherein virus checks of the e-mail can be carried out selectively at an established time of day or each time a message arrives.

22. The method according to claim 10, wherein virus checks of the e-mail can be carried out selectively at an established time of day or each time a message arrives.

23. The method according to claim 11, wherein virus checks of the e-mail can be carried out selectively at an established time of day or each time a message arrives.

24. The method according to claim 12, wherein virus checks of the e-mail can be carried out selectively at an established time of day or each time a message arrives

25. The method according to claim 10, wherein the contents of the JMB can be cyclically deleted at specific time intervals.

26. The method according to claim 11, wherein the contents of the JMB can be cyclically deleted at specific time intervals.

27. The method according to claim 12, wherein the contents of the JMB can be cyclically deleted at specific time intervals.

28. The method according to claim 13, wherein the contents of the JMB can be cyclically deleted at specific time intervals.
